(19) United States
(12) Patent Application Publication
(10) Pub. No.: US 2024/0280946 A1
(43) Pub. Date: Aug. 22, 2024

(54) FAST SURROGATE-BASED OPTIMIZATION

(71) Applicant: Geminus.AI, Inc., Cambridge, MA (US)

(72) Inventor: Gerardo De La Torre, Chicago, IL (US)

(73) Assignee: Geminus.AI, Inc., Cambridge, MA (US)

(21) Appl. No.: 18/112,877

(22) Filed: Feb. 22, 2023

(51) Int. Cl. G05B 13/02

(52) U.S. Cl. CPC G05B 13/0265

(57) ABSTRACT

A method of optimizing setting in an industrial process is described, along with associate media and systems, using a digital twin, computationally expensive physics-based model coupled with a faster machine learning (ML) model. Multiple initial guesses are subject to multiple branches of constrained objective function optimization using the ML model. In each branch, the optimized parameters are checked using the physics-based model, subject to constrain correction projection if they violate a constraint until they are in-bounds, and then logged. The best parameters are then selected from the logged parameters from all of the branches.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH AND DEVELOPMENT

NOT APPLICABLE

### BACKGROUND

### 1. Field of the Art

Embodiments of the present invention generally relate to optimizing computational models to facilitate operations or monitoring of operations in an industrial process, and more specifically to optimizing settings in the industrial process using fast, surrogate machine-learning (ML) models coupled with a more traditional physics based digital model.

### 2. Description of the Related Art

An “industrial plant” can be a facility, equipment, or a combination thereof used in connection with, or as part of, any process or system for industrial production or output. Examples of industrial plants can include plastic manufacturing plants, chemical plants, metal manufacturing plants, food processing plants, water or waste processing plants, energy production facilities, etc.

A “digital twin” can be a virtual representation of one or more real-world systems or processes. The digital twin can be a result of a culmination of technologies including artificial intelligence, physics modeling, 5G, internet of thing (IOTs), etc. For complex, real-world systems or processes, such as those performed in industrial plants, using an accurate digital twin can be difficult.

To improve the efficacy of digital twins, manual optimization techniques can be implemented to estimate parameters. The optimization techniques can involve determining values for the parameters that, when input into a digital twin, result in a most desirable output (i.e., an output with high accuracy and low uncertainty) from the digital twin. But running the digital twin can take time, and so a full exploration of the parameter space is not practical.

A surrogate model is a model of a digital twin. The surrogate model can be generated using artificial intelligence (AI)-inspired machine learning algorithms. The surrogate models can be faster and use less computational resources than the models from which they are based. However, a surrogate model is often not modeled on the underlying physics of the industrial process or plant that the digital twin is. Therefore, it may have limited fidelity outside of small ranges, or it may not capture variations within a target range.

There is a need in the art for more complete optimizations of industrial processes using digital twins.

### BRIEF SUMMARY

Certain aspects and examples of the present disclosure relate to a system and method for optimizing settings in an industrial process via fast, surrogate-based optimization. To optimize the settings, a digital model (i.e., a digital twin) of an industrial plant, or of specific processes (i.e., the industrial process) or systems within the industrial plant, is obtained. The digital model can be a physics-based digital model or a first principal model that can be based on underlying physical or chemical processes associated with the industrial plant, process, or system. Additionally, a surrogate model is generated that utilizes machine learning techniques, gaussian processes, or the like to emulate the physics-based digital model. At a high level, the digital model or the surrogate model can be used improve an understanding of sub-system interactions, predict performance metrics or outputs, aid in design or operation decisions, or perform other suitable tasks with respect to the industrial plant, process, or system. During execution of the digital model, mathematical relations, along with independent parameters (i.e., input parameters), can be solved to determine dependent parameters (i.e., outputs of the digital model). The dependent parameters can be highly accurate in comparison with a real-world output of the industrial plant, system, or process.

However, execution of the digital model can be computationally expensive. Current optimization techniques may require multiple executions of a model to converge to an optimal value. For example, a current optimization technique may include manually incrementing parameters and executing the digital model at each increment until convergence at the optimal value. Due to the digital model being computationally expensive, multiple executions of the digital model can be inefficient or impractical to perform. For example, there may be insufficient computational resources for performing the multiple executions, or a timeline for performing the multiple executions may be too long.

Due to the surrogate model being generated via machine learning algorithms or other suitable techniques rather than the underlying physical or chemical processes, there can be discrepancies between an output of the surrogate model and an output of the digital model. Moreover, in some examples, the digital model can be subject to constraints (i.e., maximum or minimum values for the independent parameters or for the dependent parameters) for which the surrogate model is unaware. Therefore, performing optimization techniques with the surrogate model alone may result in values that, when executed in the digital model, exceed the constraints or are otherwise undesirable.

Examples of the present disclosure can overcome one or more of the above-mentioned problems by performing the fast, surrogate-based optimization. For example, an optimization workflow (i.e., the fast surrogate-based optimization) can be established that can use the surrogate model to determine values for the independent parameters that optimize the dependent parameters. The use of the surrogate model to determine the values can be faster and require less computational resources than the digital model. Then, the optimization workflow can include inputting the values into the digital model to verify that constraints are met. Therefore, the optimization workflow can reduce the computational resources necessary for optimization while still verifying that an optimized solution meets all requirements (i.e., constraints) of the digital model. The optimized solution can further be implemented in the industrial plant, process, or system as the settings, thereby improving an efficiency of design or operating decisions within the industrial plant, process, or system. Moreover, multiple optimization workflows can be performed in parallel to increase a likelihood of determining an optimal solution and doing so in a time-efficient manner.

“Parallel” execution includes explicitly executing at the same time or executing at different times but functionally treating as if the executions were conducted in parallel, such as by running one and then the other and then sharing the outputs as if they had been run in parallel, or as otherwise known in the art. The term can include executing on different processors/cores or the same processor by multiplexing/interleaving in time.

In some examples, the optimization workflow may include determining, via the surrogate model, the input parameters that minimize (or maximize) an objective function. The input parameters may also be referred to as settings or as independent parameters. Additionally, the input parameters can correspond to real-world parameters that can be manipulated in operation or design such as a pressure regulator setting, a temperature, or the length of a pipe. The objective function can be constructed to reflect a relationship between the independent parameters and dependent parameters. The dependent parameters can be an output of the industrial plant such as a product produced by the industrial process, heat expenditure of the industrial process, etc., or the dependent parameters can be other suitable values dependent on the industrial process such as profit. The objective function may further reflect an operating or design goal associated with the industrial plant, process, or system. Thus, the values of the independent parameters optimized via the optimization workflow may be used as operating conditions or for design decisions in the real-world industrial plant, process, or system. Additionally, the independent parameters or the dependent parameters may be subject to constraints, which can be defined by constraint functions.

In a particular example, an independent parameter may be a temperature setting for a piece of equipment associated with a process in a chemical manufacturing plant. The objective function may quantify a relationship between the temperature setting and an output of the chemical manufacturing plant. The output can be a daily profit of the chemical manufacturing plant and an operation goal can be to maximize the daily profit. The temperature setting and other suitable independent parameters may be chosen that balance production via the process in the chemical manufacturing plant and costs of resources. Additionally, the independent parameter or the output may be subject to constraints. For example, a constraint can be a maximum temperature above which the piece of equipment cannot be set.

An algorithm for performing the fast, surrogate-based optimization can include determining a set of distinct initial guesses for an input parameter. Then, the algorithm can include generating a branch for each initial guess and executing an optimization algorithm at each branch. The steps of the algorithm described below can occur, in parallel, at each branch to increase a likelihood of finding an optimal solution for the objective function. The goal of the optimization algorithm can be to, based on the initial guess, find a value for the input parameter that minimizes (or maximizes) the objective function and meets constraints associated with the objective function. The optimization algorithm can include evaluating the initial guess and subsequent values that are based on the initial guess until an optimal value for the input parameter is determined or until the optimization algorithm fails. The evaluation can be performed using the surrogate model to improve efficiency of the optimization algorithm and reduce computational resources used for the optimization algorithm. The optimization algorithm can be any suitable optimization algorithm (e.g., gradient descent, momentum, adagrad, RMSProp, etc.). If the optimization algorithm is successful in determining the optimal value that minimizes (or maximizes) the objective function and meets the constraints, the branch can proceed to a next step in the algorithm. Otherwise, if the optimization algorithm fails, the branch may be terminated (i.e., no further computation may be performed). The next step in the algorithm can include verifying that the optimal value meets the constraints when executed on the digital model. If the constraints are met in the digital model, the optimal value can be logged as a candidate input parameter for the digital model. If one or more of the constraints are violated in the digital model, the branch can proceed to an input annealing step of the algorithm. The goal of the input annealing can be to determine a small correction for the optimal value such that the one or more constraints are no longer violated and an effect on the objective function is minimized. Therefore, the input annealing can include generating a new optimal value that can be close to the optimal value and does not violate the one or more constraints. The input annealing can determine the correction to the optimal value in an efficient manner. Additionally, the input annealing can enable candidate input parameters to be found at branches that may have otherwise failed, thereby further increasing the likelihood of finding the optimal solution for the objective function.

A second algorithm for performing the input annealing can occur within the algorithm for performing the fast, surrogate-based optimization. The second algorithm can take the objective function, the constraints, the optimal value, and values of the one or more violated constraints as inputs. The second algorithm can include determining an amount of violation for the one or more constraints. For example, a constraint can be that a temperature must be equal to or less than ninety degrees Celsius, but a value for temperature determined by executing the digital model with the optimal value can be ninety-one degrees Celsius. Therefore, the amount of violation can be one degree Celsius. The second algorithm can further include determining a targeted constraint output for the surrogate model. For example, the targeted constraint output can be a constraint on the surrogate model that is greater than or less than the violated constraint to facilitate detection of violation of the constraint by the surrogate model. Additionally, the second algorithm can include computing gradients (e.g., derivatives) for the objective function and the constraints with respect to the surrogate model. The gradients can indicate a rate of change of the objective function and the constraints in response to a change in the value of the input parameter. The second algorithm can further include modifying the gradients to minimize the rate of change of the objective function. For example, a vector direction can be determined at which the optimal value can be changed that affects the constraint while minimally affecting the objective function. Then, the second algorithm can include computing the direction of correction and updating the optimal solution based on the direction of correction. The direction of correction can be found, for example, using a standard quadratic programming algorithm. The above steps for input annealing can be repeated until a new optimal solution is found or for a certain number of loops. Then the second algorithm can output the new optimal solution.

After the second algorithm outputs the new optimal solution, the algorithm for performing the fast surrogate-based optimization can execute the digital model with the new optimal solution. If the constraints are no longer violated, the new optimal solution can be logged as a candidate input parameter. If the constraints are still violated, the input annealing may be performed again, or the branch may be terminated. In some examples, the algorithm can include a predefined rule to cause termination of a branch after a certain number of loops, a certain number of executions of the digital model, etc. Additionally, after all branches have been terminated or have produced candidate input parameters, a best input parameter can be determined. The best input parameter can be the parameter that maximizes or minimizes the objective function.

Some embodiments of the invention are related to a method of optimizing input parameters for an industrial process. The method can include providing, on a computer system, a physics-based digital model of an industrial process. The digital model can have an input setting associated with a piece of equipment in the industrial process. The digital model can be configured to generate dependent values based on the input setting. The dependent values can include a constrained value and a target value. The method can also include providing, on the computer system, a machine learning (ML) model of the industrial process. The ML model can be trained to emulate the physics-based digital model, including the input setting and the dependent values. The method can further include generating initial guesses for the input setting. Additionally, the method can include selecting an initial guess from the initial guesses, the selected initial guess associated with a computational refinement branch. The computational refinement branch can comprise maximizing or minimizing the target value produced by the ML model by running the initial guess through the ML model and by performing constrained objective function optimization using the ML model to find a refined guess of the input setting. The computational refinement branch can also comprise inputting the refined guess into the physics-based digital model to check the constrained value. The computational refinement branch can further include determining, using the physics-based digital model, that the constrained value violates a constraint and subjecting the refined guess and violated constrained value to a constraint correction projection to generate a refined input. Additionally, the computational refinement branch can include inputting the refined input into the physics-based digital model to re-check the constrained value, verifying that the constrained value no longer violates the constraint based on the re-check, and logging the refined input as a candidate input setting for the industrial process. Finally, the method can include selecting, among multiple candidate input settings for the industrial process, a best input setting. Each candidate input setting can originate from a different initial guess of the initial guesses and a respective computational refinement branch.

In some embodiments, the constrained function optimization can use a gradient-based algorithm or a trust region method. Additionally, in some embodiments, the constraint correction projection can use an input parameter perturbation technique.

In some embodiments, the constraint correction projection includes determining an amount of violation of the constraint, determining a targeted constraint output for the ML model, computing a gradient of the ML model at the refined guess for the constrained value and the target value, determining a vector direction of the gradient so as to minimally affect the target value, computing a direction of correction for the constrained value, and updating the refined guess based on the computed direction of correction. The constraint projection can be repeated in a loop.

In some embodiments, the method can further include assessing that a number of times that the physics-based model has run is fewer than a limit. The method may also include allowing the inputting of the refined input into the physics-based digital model based on the assessing.

In some embodiments, the method can further include assessing that a number of times that the physics-based model has run in a second computational refinement branch has reached a limit. The method may also include halting the second computation refinement branch based on the assessing, such that no candidate input setting is logged for the second computational refinement branch.

In some embodiments, the ML model can comprise a regression type model.

In some embodiments, the input setting can be selected from the group consisting of a voltage, a pressure regulator setting, and a length of a pipe. The constrained value can be selected from the group consisting of a temperature, a flow rate, a stress or strain level, and a waste emission. Additionally, the target value can be selected from the group consisting of a quantity of product, a chemical purity, an amount of effluent, and a carbon emission.

### BRIEF DESCRIPTION OF THE DRAWINGS

FIG. 1 is a block diagram of an example of a system for optimizing settings in an industrial process via fast surrogate-based optimization according to one example of the present disclosure.

FIG. 2 is a block diagram of another example of a system for optimizing settings in an industrial process via fast surrogate-based optimization according to one example of the present disclosure.

FIG. 3 is a block diagram of an example of a computing system for optimizing settings in an industrial process via fast surrogate-based optimization according to one example of the present disclosure.

FIG. 4 is a flowchart of an example of a process for optimizing settings in an industrial process via fast surrogate-based optimization according to one example of the present disclosure.

FIG. 5 is a flowchart of another example of a process for optimizing settings in an industrial process via fast surrogate-based optimization according to one example of the present disclosure.

### DETAILED DESCRIPTION

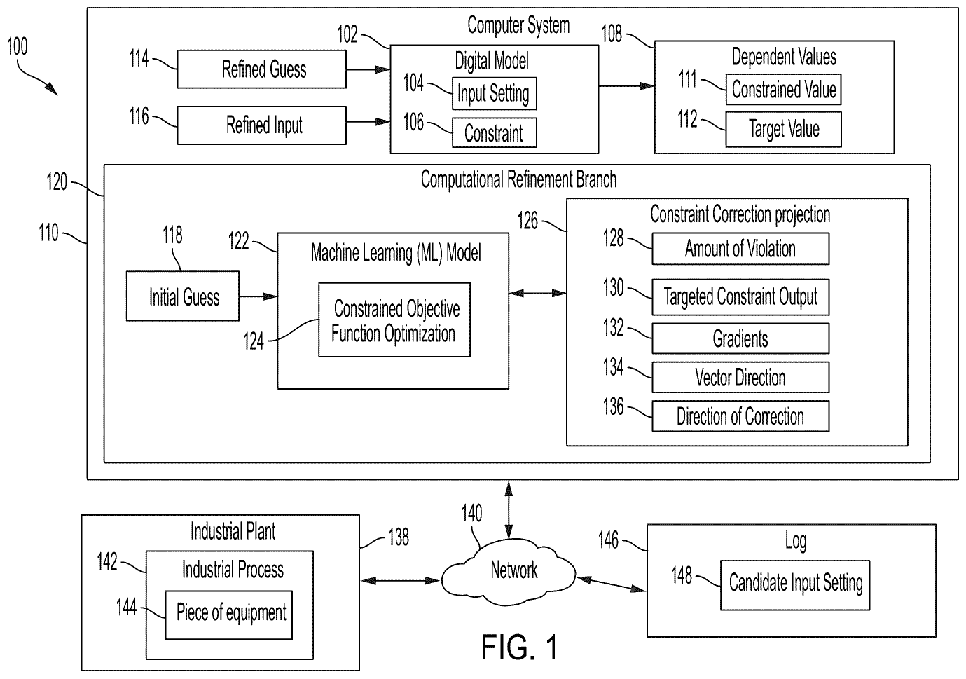

FIG. 1 is a block diagram of an example of a system 100 for optimizing settings in an industrial process 142 via fast surrogate-based optimization according to one example of the present disclosure. The system 100 can provide, on a computer system 110, a digital model 102, which can be a digital twin of an industrial plant 138. In some examples, the industrial plant 138 can be a water distribution system, a chemical plant, a metal manufacturing plant, a food processing plant, or another suitable industrial plant. Thus, the digital model 102 can be a virtual representation of the industrial plant 138 or a virtual representation of specific processes (e.g., industrial process 142) or systems associated with the industrial plant 138. Additionally, the digital model 102 can be a physics-based digital model or a first principal model that can be based on underlying physical or chemical processes associated with the industrial plant, process, or system.

The digital model 102 can have an input setting 104 associated with a piece of equipment 144 in the industrial process 142. The input setting 104 can be a controllable parameter than can be set on or for a piece of equipment 144. For example, the input setting 104 can be a volage, a pressure regulator setting, a length of a pipe, a temperature, etc. The system 100 can further generate dependent values 108 based on the input setting 104. The dependent values 108 can include a constrained value 111 and a target value 112. The constrained value 111 can be the target value 112 or another suitable dependent parameter of the digital model 102 that can be bounded by a constraint 106. For example, the constraint 106 can be a value above or below which a temperature value (i.e., a constrained value) may cause damage to the piece of equipment 144 or otherwise be undesirable. Additionally, an objective function can be constructed to define a relationship between the input setting 104 and the dependent values 108. The objective function may further reflect an operating or design goal (i.e., the target value 112) associated with the industrial process 142. For example, the target value 112 can be a quantity of a product, a chemical purity, an amount of effluent, a carbon emission, or another suitable value that can be maximized or minimized for the industrial process 142.

The system 100 can also provide, on the computer system 110, a machine learning (ML) model 122 of the industrial process 142. The ML model 122 can be trained to emulate the digital model 102, including the input setting 104 and the dependent values 108, such that the ML model 122 can be a surrogate model of the digital model 102. The ML model 122 can be generated by or include a neural network, decision tree, or other suitable ML algorithm. Additionally, the ML model 122 can be trained to predict an output of the digital model 102. For example, the ML model 122 can be a regression type model in which a dependent value, such as the target value 112, can be estimated based on a relationship with one or more independent values, such as the input setting 104. The ML model 122 can be less computationally expensive and execute faster than the digital model 102.

Additionally, the system 100 can generate initial guesses for the input setting 104. The initial guesses can be randomly selected, or the initial guesses can be estimated based on previous models, experimental data, real-world settings associated with the piece of equipment 144 or industrial process 142, or other suitable data or values. The initial guesses can be different values to enable the system 100 to generate various candidate input settings, one of which may be a best input setting.

After generating the initial guesses, the system 100 can select an initial guess 118 from the initial guesses. The selected initial guess 118 can be associated with a computational refinement branch 120. Therefore, the system 100 can execute the computational refinement branch 120. The system 100 may also execute each of the remaining initial guesses in respective computational refinement branches in parallel to the computational refinement branch 120.

Within the computational refinement branch 120, the system 100 can maximize or minimize the target value 112 by running the initial guess through the ML model 122 and by performing constrained objective function optimization 124 using the ML model 122. For example, the system 100 can use a gradient based algorithm, a trust region method, or another suitable optimization algorithm in the constrained objective function optimization 124 to generate values based on the initial guess 118. Each value generated can be an improved value for the input setting 104 in that each value may further maximize or minimize the target value 112. Additionally, the system 100 may evaluate each of the values using the ML model 122. The system 100 can continue generating and evaluating the optimized values until the constrained objective function optimization 124 converges or otherwise determines an optimal value (i.e., a refined guess 114).

Then, the system 100 can input the refined guess 114 into the digital model 102 and execute the digital model 102 to generate the constrained value 111 and the target value 112. The system may determine, based on the execution of the digital model 102 with the refined guess 114, that the constrained value 111 violates the constraint 106. In response, the system 100 may subject the refined guess 114 and the constrained value 111 to a constraint correction projection 126 (e.g., an input annealing algorithm) to generate a refined input 116. The constraint correction projection 126 can use an input parameter perturbation technique to generate the refined input 116.

In a particular example, the constraint correction projection 126 can include the system 100 determining an amount of violation 128 of the constraint 106. The system 100 may determine the amount of violation 128 but subtracting the constrained value 111 generated by the digital model 102 with the refined guess 114 from the constraint if the constraint is an upper boundary or vice versa if the constraint 106 is a lower boundary. The constraint correction projection 126 can further include the system 100 determining a targeted constraint output 130 for the ML model 122. The targeted constraint output 130 can be a constraint on the ML model 122 that is greater than or less than the violated constraint 106 to facilitate detection of violation of the constraint 106 by the ML model. The constraint correction projection 126 can also include the system 100 computing gradients 132 of the ML model 122 at the refined guess 114 for the constrained value 111 and the target value 112. The gradient 132 can include derivatives and indicate a rate of change of the constrained value 111 and the target value 112 based on a change to the refined guess 114.

Additionally, the constraint correction projection 126 can include the system 100 determining a vector direction 134 of the gradients 132 that can affect the constrained value 111 while minimally affecting the target value 112. Moreover, the constraint correction projection 126 can include the system 100 computing a direction of correction 136, based on the vector direction 134, for the constrained value 111 and updating the refined guess 114 based on the direction of correction 136 to generate a refined input 116.

After generating the refined input 116, the system 100 can input the refined input 116 into the digital model 102 to re-check the constrained value 111. In doing so, the system 100 can verify that the constrained value 111 no longer violates the constraint 106. If the constrained value 111 no longer violates the constraint 106, the system 100 can save the refined input 116 in a log 146 as a candidate input setting 148. In some examples, the constrained value 111 may be violated at the re-check, and the system 100 may perform the constraint correction projection 126 in a loop until a candidate input setting can be determined. In other examples, the system 100 may assess a number of times that the constraint correction projection 126 has been performed, a number of times the digital model 102 has been executed, etc. The system 100 may compare the number of times for the digital model 102 or the constraint correction projection 126 to a limit. If the number is below the limit, the system may continue to perform the constraint correction projection 126 or execute the digital model 102. Or, if the number if is above the limit, the system 100 may halt or terminate the computational refinement branch 120 and no candidate input parameter may be logged for the computational refinement branch 120.

In some examples, the system 100 may execute a computational refinement branch for each initial guess generated and the system 100 may generate and save more than one candidate input setting based at least a portion of the initial guesses. Therefore, the system 100 can further select, among multiple candidate input settings, a best input setting. The best input setting can be the candidate input setting at which the target value 112 is the greatest or the lowest depending on whether the design or operational goal was to maximize or minimize the target value 112. Additionally, the piece of equipment 144 or another suitable aspect of the industrial process 142 can be set to the best input setting.

Therefore, the system 100 can provide an efficient method for optimizing the input setting 104 in the industrial process 142. For example, the system 100 can minimize execution of the digital model 102 by using the ML model 122 in the constrained objective function optimization 124, thereby saving time and computational resources. The implementation of the constraint correction projection 126 to correct for differences between the ML model 122 and the digital model 102 further enables the use of the ML model. Additionally, the constraint correction projection 126 can increase a number of candidate input settings found by generating refined inputs at computational refinement branches that may have otherwise failed, which can increase a likelihood of finding a best input setting. The system can further increase the likelihood of finding the best input setting by executing more than one computational refinement branch in parallel.

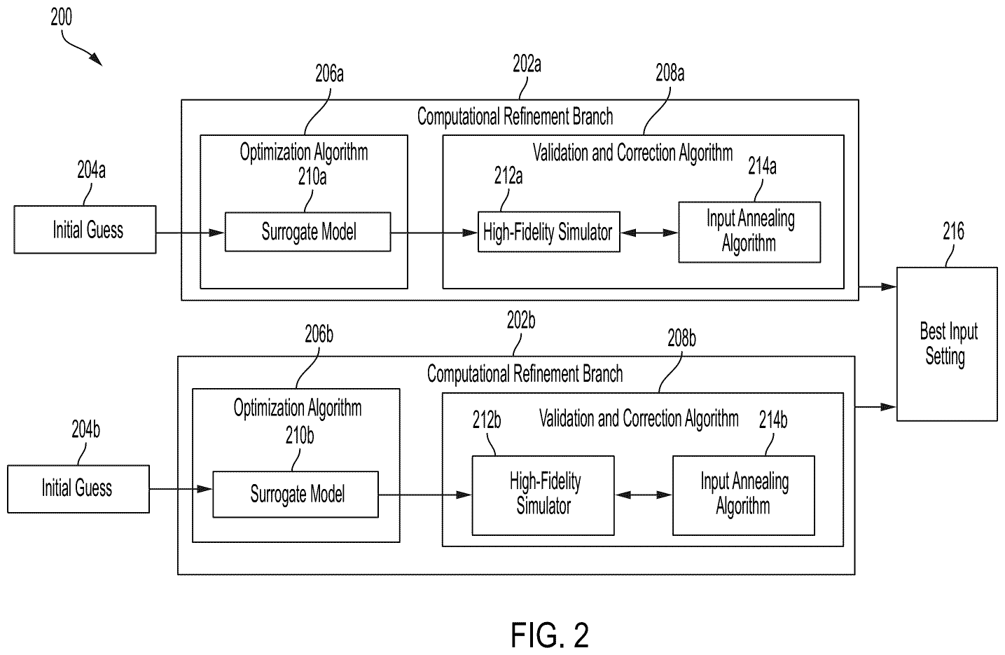

FIG. 2 is a block diagram of another example of a system 200 for optimizing settings in an industrial process via fast surrogate-based optimization according to one example of the present disclosure. The system 200 can include a first computational refinement branch 202a and a second computational refinement branch 202b. Some embodiments may have more, many more, branches. The system 200 may, via the computational refinement branches 202a-b, execute a first optimization algorithm 206a using a first initial guess 204a and a second optimization algorithm 206b using a second initial guess 204b. The system 200 may execute the optimization algorithms 206a-b in parallel. The system 200 may, via the computational refinement branches 202a-b, execute a first validation and correction algorithm 208a on a first optimal value generated by the first optimization algorithm 206a and execute a second validation and correction algorithm 208b on a second optimal value generated by the second optimization algorithm 206b. The system 200 may also execute the validation and correction algorithms 208a-b in parallel.

The system 200 may perform the fast surrogate-based execution. For example, the system 200 may begin the fast surrogate-based optimization by determining the initial guesses 204a-b. The initial guesses 204a-b can be values for an input parameter of a high-fidelity simulator. The high-fidelity simulator can be a physics-based digital model of the industrial process and the input parameter can correspond to a setting in the industrial process. The initial guesses 204a-b may be randomly chosen, or the initial guesses 204a-b can be estimated based on a similar setting in a similar industrial process, experimental data, or other suitable values or data. The system 200 may further select the first initial guess for use in the first computational refinement branch 202a and select the second initial guess 204b for use in the second computational refinement branch 202b.

At the computational refinement branches 202a-b, the system 200 can execute the optimization algorithms 206a-b. The optimization algorithms 206a-b can be any suitable optimization algorithm (e.g., gradient descent, momentum, adagrad, RMSProp, etc.). The goal of the optimization algorithms 206a-b can be to, based on the initial guesses 204a-b, find values for the input parameter that minimize (or maximize) a target value. For example, the target value can be the amount of product produced by the industrial process. Additionally, an objective function can be constructed to reflect a relationship between the input parameter and the target value such that maximizing the objective function maximizes the target value. Moreover, constraints can be determined by which the input parameter, the target value, or other suitable independent or dependent parameters associated with the high-fidelity simulator can be bounded.

Execution of the optimization algorithms 206a-b can include evaluating the initial guesses 204a-b, determining increasingly optimal values based on the initial guesses 206a-b, and evaluating the increasingly optimal values until the optimization algorithms 206a-b converge at, or otherwise determine, optimized values for the input parameter. The evaluating can be performed using a first surrogate model 210a and a second surrogate model 210b. The surrogate models 210a-b can be artificial intelligence (AI) inspired machine learning models or other suitable types of surrogate models. The first surrogate model 210a and the second surrogate model 210b can predict outputs of a first high-fidelity simulator 212a and a second high-fidelity simulator 212b respectively. Therefore, the surrogate models 210a-b can be lower-fidelity versions of the high-fidelity simulators 214a-b, which can increase a speed and efficiency of determining the optimized values.

After the optimization algorithms 206a-b determine the optimized values, the system 200 execute the validation and correction algorithms 208a-b. For example, the system 200 can verify that the optimized values meet the constraints by executing the high-fidelity simulators 212a-b with the optimized values. If the optimized values do not violate the constraints, the optimized values can be logged as candidate input parameters. Conversely, if the optimized values do violate one or more of the constraints, the system can perform input annealing. For example, the first optimized value may violate a constraint when executed on the first high-fidelity simulator 212a. Therefore, the system 200 can execute a first input annealing algorithm 214a. Additionally, in the example, the second optimized value may not violate the constraints when executed on the second high-fidelity simulator 212b. Therefore, the system 200 can bypass a second input annealing algorithm 214b and log the second optimized value as a first candidate input parameter.

The first input annealing algorithm 214a can take the target value, the objective function, the constraints, the first optimized value, and a value of the high-fidelity simulator that violates the constraint as input. Then, the system 200 can, via the first input annealing algorithm 214a, determine an amount of violation for the constraint. The system 200 can further, via the first input annealing algorithm 214a, determine a targeted constraint output for the first surrogate model 210a. Additionally, the system 200 can, via the first input annealing algorithm 214a, compute gradients (i.e., derivatives) for the objective function and the constraints with respect to the first surrogate model 210a. The gradients can be indicative of a rate of change of the objective function and the constraints in response to a change in the first optimized value. The system 200 can further modify the gradients to minimize the rate of change of the objective function via the first input annealing algorithm 214a. Additionally, the system 200 can compute, via the first input annealing algorithm 214a, a direction of correction and update the first optimized value based on the direction of correction. The system 200 may execute the first high-fidelity simulator 212a with the updated first optimized value to check if the constraint is violated. If the constraint is violated, the system 200 may execute the first input annealing algorithm 214a again to generate another optimized value. If the constraint is not violated, the system 200 may log the updated first optimized value as a second candidate input parameter.

In some examples, the system 200 can include predefined rules to cause termination of the computational refinement branches 202a-b after a certain number of loops, a certain number of executions of the high-fidelity simulators 212a-b, etc. Additionally, after the computational refinement branches 202a-b have been terminated or have produced candidate input parameters, a best input parameter 216 can be determined. The best input parameter 216 can be the parameter that maximizes or minimizes the target value

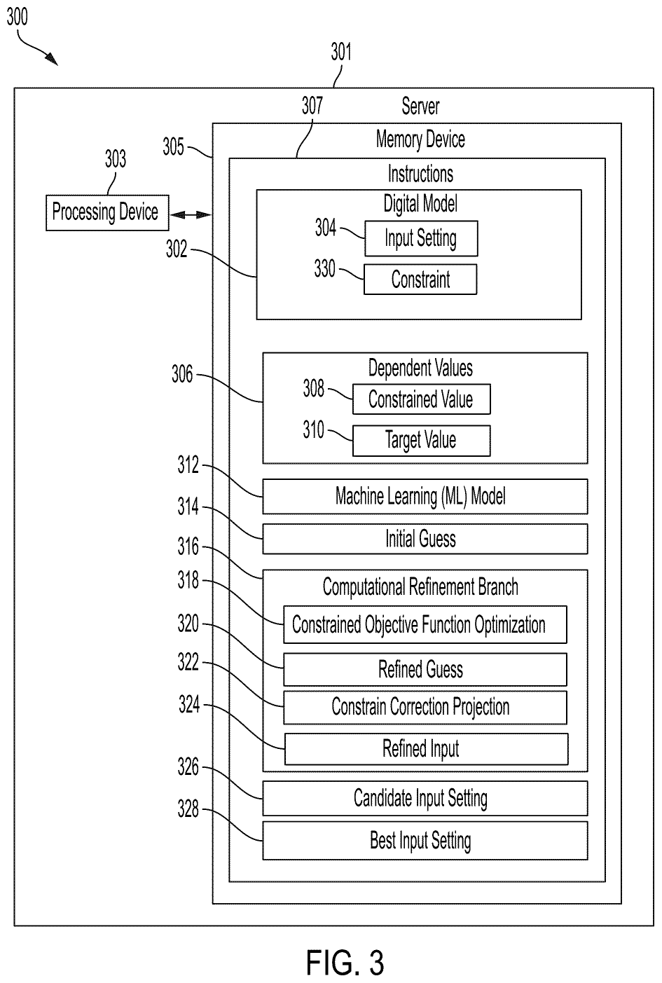

FIG. 3 is a block diagram of an example of a computing system 300 for optimizing settings in an industrial process via fast surrogate-based optimization according to one example of the present disclosure. The computing system 300 includes a processing device 303 that is communicatively coupled to a memory device 305. In some examples, the processing device 303 and the memory device 305 can be part of the same computing device, such as the server 301. In other examples, the processing device 303 and the memory device 305 can be distributed from (e.g., remote to) one another.

The processing device 303 can include one processor or multiple processors. Non-limiting examples of the processing device 303 include a Field-Programmable Gate Array (FPGA), an application-specific integrated circuit (ASIC), or a microprocessor. The processing device 303 can execute instructions 307 stored in the memory device 305 to perform operations. The instructions 307 may include processor-specific instructions generated by a compiler or an interpreter from code written in any suitable computer-programming language, such as C, C++, C #, Java, or Python.

The memory device 305 can include one memory or multiple memories. The memory device 305 can be volatile or non-volatile. Non-volatile memory includes any type of memory that retains stored information when powered off Examples of the memory device 305 include electrically erasable and programmable read-only memory (EEPROM) or flash memory. At least some of the memory device 305 can include a non-transitory computer-readable medium from which the processing device 303 can read instructions 307. A non-transitory computer-readable medium can include electronic, optical, magnetic, or other storage devices capable of providing the processing device 303 with computer-readable instructions or other program code. Examples of a non-transitory computer-readable medium can include a magnetic disk, a memory chip, ROM, random-access memory (RAM), an ASIC, a configured processor, and optical storage.

The processing device 303 can execute the instructions 307 to perform operations. For example, the processing device 303 can provide, on a computer system, a digital model 302 of an industrial process. The digital model 302 can have an input setting 304 associated with a piece of equipment in the industrial process. The processing device 303 can configure the digital model 302 to generate dependent values 306 based on the input setting 304. The dependent values 306 can include a constrained value 308 and a target value 310. The processing device 303 can also provide, on the computer system, a machine learning (ML) model 312 of the industrial process. The ML model 312 can be trained to emulate the digital model 302, including the input setting 304 and the dependent values 306. The processing device 303 can further generate initial guesses for the input setting 304. Additionally, the processing device 303 can select an initial guess 314 from the initial guesses, the selected initial guess 314 associated with a computational refinement branch 316. The computational refinement branch can comprise the processing device 303 maximizing or minimizing the target value 310 produced by the ML model 312 by running the initial guess 314 through the ML model 312 and by performing constrained objective function optimization 318 using the ML model 312 to find a refined guess 320 of the input setting 304. The computational refinement branch can also comprise the processing device 303 inputting the refined guess 320 into the digital model 302 to check the constrained value. The computational refinement branch 316 can further include the processing device 303 determining, using the digital model 302, that the constrained value 308 violates a constraint 330 and subjecting the refined guess 320 and violated constraint value to a constraint correction projection 322 to generate a refined input 324. Additionally, the computational refinement branch 316 can include the processing device 303 inputting the refined input 324 into the digital model 302 to re-check the constrained value 308, verifying that the constrained value 308 no longer violates the constraint 330 based on the re-check, and logging the refined input 324 as a candidate input setting 326 for the industrial process. Finally, the processing device 303 can select, among multiple candidate input settings for the industrial process, a best input setting 328. Each candidate input setting can originate from a different initial guess of the initial guesses and a respective computational refinement branch.

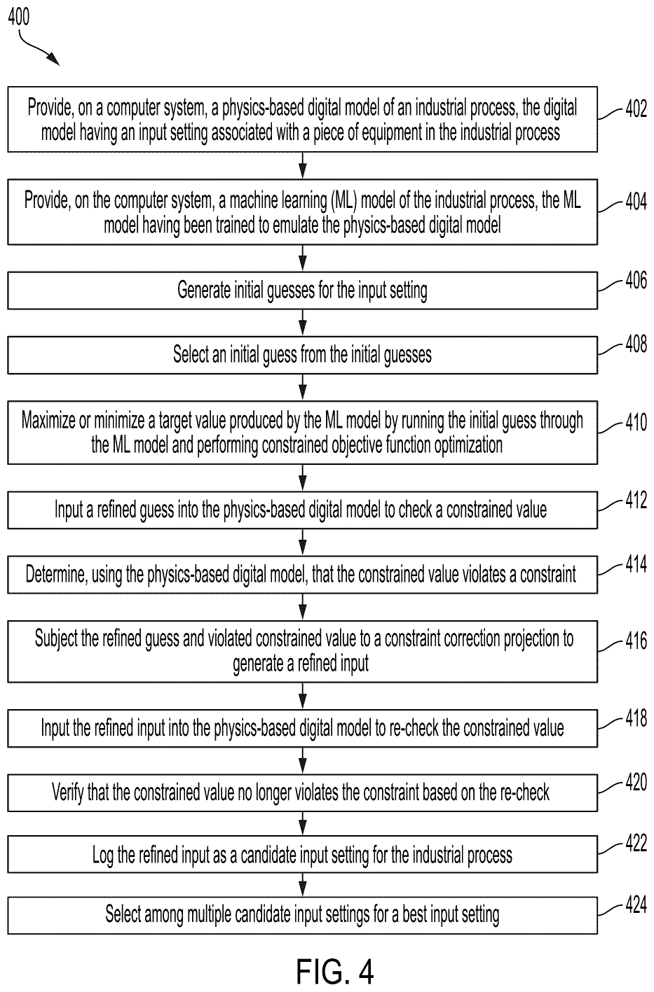

FIG. 4 is a flowchart of an example of a process 400 for optimizing settings in an industrial process via fast surrogate-based optimization according to one example of the present disclosure. In some examples, the processing device 303 (in FIG. 3) can implement some or all of the steps shown in FIG. 4. Other examples can include more steps, fewer steps, different steps, or a different order of the steps than is shown in FIG. 4. The steps of the figure are discussed below with reference to the components discussed above in relation to FIGS. 1 and 3.

At block 402, the processing device 303 (see FIG. 3) can provide, on a computer system 110 (see FIG. 1), a physics-based digital model 102 of an industrial process 142, the digital model 102 having an input setting 104 associated with a piece of equipment 144 in the industrial process 142. The digital model 102 can be configured to generate dependent values 108 based on the input setting 104. The input setting 104 can be a controllable parameter than can be set on or for the piece of equipment 144. For example, the input setting 104 can be a volage, a pressure regulator setting, a length of a pipe, a temperature, etc. The dependent values 108 can include a constrained value 111 and a target value 112. The constrained value 111 can be based on a constraint 106, where the constraint 106 can be a value above or below which the constrained value 111 may cause damage to the piece of equipment 144 or otherwise be undesirable. Additionally, an objective function can be constructed to define a relationship between the input setting 104 and the dependent values 108. The objective function may further reflect an operating or design goal associated with the industrial plant, process, or system (i.e., the target value 112). For example, the target value 112 can be oil production, profit, etc. and the operating or design goal reflected by the objective function can be to maximize oil production or profit. In another example, the target value 112 can be selected from a group consisting of a quantity of a product, a chemical purity, an amount of effluent, and a carbon emission.

At block 404, the processing device 303 can provide, on the computer system 110, a machine learning (ML) model 122 of the industrial process 142, the ML model 122 having been trained to emulate the physics-based digital model 102. Thus, the ML model 122 can be a surrogate model of the digital model and can include the input setting 104 and the dependent values 108. The ML model 122 can be generated by or include a neural network, decision tree, or other suitable ML algorithm. In some examples, the ML model 122 can be a regression type model. The ML model 122 can be trained to predict an output of the digital model 102. Additionally, the ML model 122 can be less computationally expensive and execute faster than the digital model 102.

At block 406 the processing device 303 can generate initial guesses for the input setting 104. In some examples, the initial guesses can be randomly selected. In other examples, the initial guesses can be estimated based on previous models, experimental data, real-world settings associated with the piece of equipment 144 or industrial process 142, etc. The initial guesses can be different values to enable an optimization algorithm to generate varying optimal solutions, one of which may be a best optimal solution for the objective function.

At block 408, the processing device 303 can select an initial guess 118 from the initial guesses. The initial guess 118 can be associated with a computational refinement branch 120. The computational refinement branch 120 can be a branch at which the initial guess 118 can be optimized, corrected, verified, executed, etc. in the ML model 122, the digital model 102, or a combination thereof. In some examples, the processing device 303 or additional computing devices may select the remainder of the initial guesses such that each of the initial guesses can be optimized in parallel at respective computational refinement branches.

At block 410, the processing device 303 can maximize or minimize the target value 112 produced by the ML model 122 by running the initial guess 118 through the ML model 122 and performing constrained objective function optimization 124. The maximizing or minimizing of the target value can occur within the computational refinement branch. The constrained objective function optimization 124 can be performed using the ML model 122 to determine a refined guess 114 for the input setting 104. For example, the constrained objective function optimization 124 can use a gradient based algorithm, a trust region method, or another suitable optimization algorithm or technique to generate values based on the initial guess 118 and the values can be evaluated using the ML model 122. The constrained objective function optimization 124 may continue until the optimization technique or algorithm used converges or otherwise produces an optimal value, which can be the refined guess 114.

At block 412, the processing device 303 can input the refined guess 114 into the physics-based digital model 102 to check a constrained value 111. The constrained value 111 can be a value for the input setting 104, the target value 112, or another suitable independent or dependent parameter can be bounded by a constraint 106. In some examples, the constrained value 111 may be selected from a group consisting of a temperature, a flow rate, a stress or strain level, a waste emission, etc.

Additionally or alternatively, the processing device 303 may assess a number of times that the digital model 102 has been executed and compare the number to a limit. The processing device 303 may allow or not allow the refined guess 114 to be input into the digital model 102 based on the assessing. For example, the processing device 303 may assess that the number times the digital model has been executed within the computational refinement branch 120 is fewer than the limit and may allow the refined input 116 to be input into the digital model 102. In another example, the processing device 303 may assess that the number of times that the digital model 102 has been run (i.e., executed) in a second computational refinement branch has reached the limit. In response, the processing device 303 may halt or terminate the second computational refinement branch such that no candidate input setting can be logged for the second computational refinement branch.

At block 414, the processing device 303 can determine, using the physics-based digital model 102, that the constrained value 111 violates the constraint 106. In some examples, there can be differences between the ML model 122 and the digital model 102. Due to the differences, the refined guess 114 may result in a constrained value 111 that does not violate the constraint 106 when input in the ML model 122, but the refined guess 114 may result in a constrained value 111 that does violate the constraint 106 when input in the digital model 102.

At block 416, the processing device 303 can subject the refined guess 114 and violated constrained value 111 to a constraint correction projection 126 to generate a refined input 116. The constraint correction projection 126 can use an input parameter perturbation technique. Additionally, steps for performing the constraint correction projection 126 can include determining an amount of violation of the constraint 106, determining a targeted constraint output 130 for the ML model 122, computing gradients 132 of the ML model 122 at the refined guess 114 for the constrained value 111 and the target value 112, determining a vector direction 134 of the gradients 132 so as to minimally affect the target value 112, computing a direction of correction 136 for the constrained value, and updating the refined guess 114 based on the computed direction of correction 136 to generate the refined input 116. Any portion of steps for the constraint correction projection 126 can be repeated in a loop.

At block 418, the processing device 303 can input the refined input 116 into the physics-based digital model 102 to re-check the constrained value 111. In some examples, the refined input 116 may violate the constrained value 111 at the re-recheck. Therefore, the processing device 303 may terminate the computational refinement branch 120 or the processing device 303 may subject the refined input 116 and violated constrained value 111 to the constraint correction projection 126 again. In some examples, the constraint correction projection 126 can be repeated up to a certain number of times or the constraint correction projection 126 may be repeated until the constrained value 111 is no longer violated.

At block 420, the processing device 303 can verify that the constrained value 111 no longer violates the constraint based on the re-check. The processing device 303 can verify the constrained value 111 is no longer violated based on an output of the digital model 102. The constrained value 111 no longer being violated can indicate that the constraint correction projection 126 was successful.

At block 422, the processing device 303 can log 146 the refined input 116 as a candidate input setting 148 for the industrial process 142. The log 146 can include candidate input settings for each of the initial guesses for which a candidate input setting was successfully found.

At block 424, the processing device 303 can select among multiple candidate input settings for a best input setting. The best input setting can be the candidate input setting at which the target value 112 is greatest or lowest based on whether the goal was to maximize or minimize the target value 112.

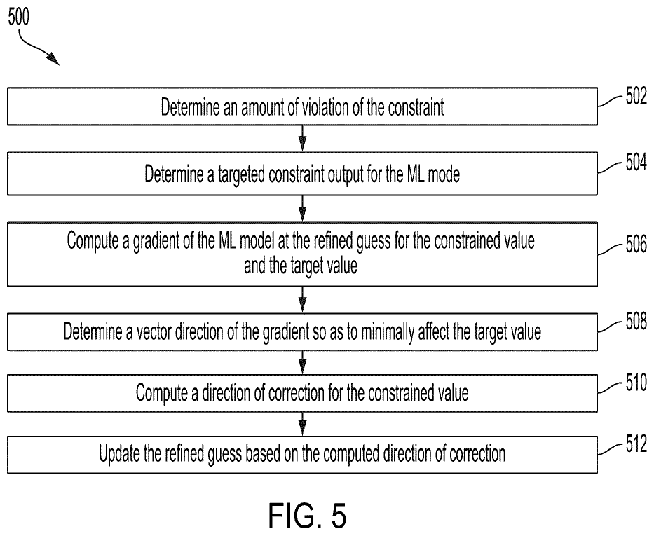

FIG. 5 is a flowchart of another example of a process 500 for optimizing settings in an industrial process via fast surrogate-based optimization according to one example of the present disclosure. The process 500 can be a process for performing constraint correction projection (i.e., input annealing). In some examples, the processing device 303 (in FIG. 3) can implement some or all of the steps shown in the figure. Other examples can include more steps, fewer steps, different steps, or a different order of the steps than is shown in the figure. The steps of the figure are discussed below with reference to the components discussed above in relation to FIGS. 1 and 3.

At block 502, the processing device 303 (see FIG. 3) can determine an amount of violation 128 (see FIG. 1) of a constraint 106. For example, a refined guess 114 can be generated using a ML model 122 that emulates a physics-based digital model 102 and by performing constrained objective function optimization 124. Once generated, the refined guess 114 can be input in the digital model 102 and a value for the constraint 106 can be generated that violates a constrained value 111 set for the digital model 102. The amount of violation 128 can be a difference between the value generated for the constraint 106 with the refined guess 114 and the constrained value 111.

At block 504, the processing device 303 can determine a targeted constraint output 130 for the ML model 122. For example, the targeted constraint output 130 can be a constrained value for the ML model 122 that is greater than or less than the constrained value 111 to facilitate the ML model 122 determining a value that does not violate the constrained value 111.

At block 506, the processing device 303 can compute gradients 132 of the ML model 122 at the refined guess 114 for the constrained value 111 and the target value 112. The gradients 132 can indicate a rate of change of the target value and of the constraints in response to a change in the refined guess 114.

At block 508, the processing device 303 can determine a vector direction of the gradient so as to minimally affect the target value 112. The vector direction can further be determined such that it does affect the constrained value 111.

At block 510, the processing device 303 can compute a direction of correction for the constrained value. The direction of correction can be found, for example, using a standard quadratic programming algorithm.

At block 512, the processing device 303 can update the refined guess 114 based on the computed direction of correction 136. The update to the refined guess 114 can generate a refined input 116. The refined input 116 can be input in the digital model 102 to re-check the constrained value 111. If the constrained value 111 is violated, the above steps for input annealing can be repeated until a new optimal solution is found or for a certain number of loops. If the constrained value 111 is no longer violated, the processing device 303 can output the refined input 116 as a candidate input parameter.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” in reference to a temperature or other engineering units includes measurements or settings that are within ±1%, ±2%, +5%, ±10%, or other tolerances of the specified engineering units as known in the art.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements, but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for optimizing settings in an industrial process, the method comprising:
providing, on a computer system, a physics-based digital model of an industrial process, the digital model having an input setting associated with a piece of equipment in the industrial process, the digital model configured to generate dependent values based on the input setting, the dependent values including a constrained value and a target value;
providing, on the computer system, a machine learning (ML) model of the industrial process, the ML model having been trained to emulate the physics-based digital model, including the input setting and the dependent values;
generating initial guesses for the input setting;
selecting an initial guess from the initial guesses, the selected initial guess associated with a computational refinement branch, the branch comprising:
maximizing or minimizing the target value produced by the ML model by running the initial guess through the ML model and performing a constrained objective function optimization using the ML model to find a refined guess of the input setting;
inputting the refined guess into the physics-based digital model to check the constrained value;
determining, using the physics-based digital model, that the constrained value violates a constraint;
subjecting the refined guess and violated constrained value to a constraint correction projection to generate a refined input;
inputting the refined input into the physics-based digital model to re-check the constrained value;
verifying that the constrained value no longer violates the constraint based on the re-check; and
logging the refined input as a candidate input setting for the industrial process;
selecting among multiple candidate input settings for a best input setting, each candidate input setting originating from a different initial guess of the initial guesses and a respective computational refinement branch.

2. The method of claim 1 wherein the constrained function optimization uses a gradient-based algorithm or a trust region method.

3. The method of claim 1 wherein the constraint correction projection uses an input parameter perturbation technique.

4. The method of claim 1 wherein the constraint correction projection includes:
determining an amount of violation of the constraint;
determining a targeted constraint output for the ML model;
computing a gradient of the ML model at the refined guess for the constrained value and the target value;
determining a vector direction of the gradient so as to minimally affect the target value;
computing a direction of correction for the constrained value; and
updating the refined guess based on the computed direction of correction.

5. The method of claim 4 wherein the constraint correction projection is repeated in a loop.

6. The method of claim 1 further comprising:
assessing that a number of times that the physics-based digital model has run is fewer than a limit; and
allowing the inputting of the refined input into the physics-based digital model based on the assessing.

7. The method of claim 1 further comprising:
assessing that a number of times that the physics-based digital model has run in a second computational refinement branch has reached a limit; and
halting the second computation refinement branch based on the assessing, such that no candidate input setting is logged for the second computational refinement branch.

8. The method of claim 1 wherein the ML model comprises a regression type model.

9. The method of claim 1 wherein the input setting is selected from the group consisting of a voltage, a pressure regulator setting, and a length of a pipe.

10. The method of claim 1 wherein the constrained value is selected from the group consisting of a temperature, a flow rate, a stress or strain level, and a waste emission.

11. The method of claim 1 wherein the target value is selected from the group consisting of a quantity of product, a chemical purity, an amount of effluent, and a carbon emission.

12. A machine-readable tangible medium embodying information indicative of instructions for causing one or more machines to perform operations for optimizing input parameters for an industrial process, the instructions comprising:
providing, on a computer system, a physics-based digital model of an industrial process, the digital model having an input setting associated with a piece of equipment in the industrial process, the digital model configured to generate dependent values based on the input setting, the dependent values including a constrained value and a target value;
providing, on the computer system, a machine learning (ML) model of the industrial process, the ML model having been trained to emulate the physics-based digital model, including the input setting and the dependent values;
generating initial guesses for the input setting;
selecting an initial guess from the initial guesses, the selected initial guess associated with a computational refinement branch, the branch comprising:
maximizing or minimizing the target value produced by the ML model by running the initial guess through the ML model and performing a constrained objective function optimization using the ML model to find a refined guess of the input setting;
inputting the refined guess into the physics-based digital model to check the constrained value;
determining, using the physics-based digital model, that the constrained value violates a constraint;
subjecting the refined guess and violated constrained value to a constraint correction projection to generate a refined input;
inputting the refined input into the physics-based digital model to re-check the constrained value;
verifying that the constrained value no longer violates the constraint based on the re-check; and
logging the refined input as a candidate input setting for the industrial process;
selecting among multiple candidate input settings for a best input setting, each candidate input setting originating from a different initial guess of the initial guesses and a respective computational refinement branch.

13. The medium of claim 12 wherein the constrained function optimization uses a gradient-based algorithm or a trust region method.

14. The medium of claim 12 wherein the constraint correction projection uses an input parameter perturbation technique.

15. The medium of claim 12 wherein the constraint correction projection includes:
determining an amount of violation of the constraint;
determining a targeted constraint output for the ML model;
computing a gradient of the ML model at the refined guess for the constrained value and the target value;
determining a vector direction of the gradient so as to minimally affect the target value;
computing a direction of correction for the constrained value; and
updating the refined guess based on the computed direction of correction.

16. The medium of claim 15 wherein the constraint correction projection is repeated in a loop.

17. A system for optimizing input parameters for an industrial process, the system comprising:
a memory; and
at least one processor operatively coupled with the memory and executing program code from the memory for:
providing, on a computer system, a physics-based digital model of an industrial process, the digital model having an input setting associated with a piece of equipment in the industrial process, the digital model configured to generate dependent values based on the input setting, the dependent values including a constrained value and a target value;
providing, on the computer system, a machine learning (ML) model of the industrial process, the ML model having been trained to emulate the physics-based digital model, including the input setting and the dependent values;
generating initial guesses for the input setting;
selecting an initial guess from the initial guesses, the selected initial guess associated with a computational refinement branch, the branch comprising:
maximizing or minimizing the target value produced by the ML model by running the initial guess through the ML model and performing a constrained objective function optimization using the ML model to find a refined guess of the input setting;
inputting the refined guess into the physics-based digital model to check the constrained value;
determining, using the physics-based digital model, that the constrained value violates a constraint;
subjecting the refined guess and violated constrained value to a constraint correction projection to generate a refined input;
inputting the refined input into the physics-based digital model to re-check the constrained value;
verifying that the constrained value no longer violates the constraint based on the re-check; and
logging the refined input as a candidate input setting for the industrial process;
selecting among multiple candidate input settings for a best input setting, each candidate input setting originating from a different initial guess of the initial guesses and a respective computational refinement branch.

18. The system of claim 17 wherein the constrained function optimization uses a gradient-based algorithm or a trust region method.

19. The system of claim 17 wherein the constraint correction projection uses an input parameter perturbation technique.

20. The system of claim 17 wherein the constraint correction projection includes:
determining an amount of violation of the constraint;
determining a targeted constraint output for the ML model;
computing a gradient of the ML model at the refined guess for the constrained value and the target value;
determining a vector direction of the gradient so as to minimally affect the target value;
computing a direction of correction for the constrained value; and
updating the refined guess based on the computed direction of correction.

21. The system of claim 20 wherein the constraint correction projection is repeated in a loop.
